(19) United States
(12) Patent Application Publication
(10) Pub. No.: US 2010/0118355 A1
(43) Pub. Date: May 13, 2010

(54) Image reading apparatus

(75) Inventor: Yoshihiro Hanagata, Minamikoma-gun (JP)

Correspondence Address: KANESAKA BERNER AND PARTNERS LLP, 1700 DIAGONAL RD, SUITE 310, ALEXANDRIA, VA, 22314-2848, US

(73) Assignee: NISCA CORPORATION, Minamikoma-gun (JP)

(21) Appl. No.: 12/588,632

(22) Filed: Oct. 22, 2009

(30) Foreign Application Priority Data
Nov. 11, 2008 (JP) 2008-288404

(51) Int. Cl. H04N 1/04

(52) U.S. Cl. 358/475

(57) ABSTRACT

To provide an image reading apparatus capable of reading original document images while performing control for blinking a line light source in the apparatus without causing a change in the hue of read data of the documents, the image reading apparatus is to apply light to an original document, read the reflected light, and thereby acquire image data of the document, and has a line light source for applying light to an original document, driving means for moving the document or a carriage installed with the line light source, a line sensor for receiving the reflected light of the document moving in the sub-scanning direction relatively to the carriage to convert into image data, and control means for performing control for blinking the line light source, control for driving the driving means, and control for capturing the image data from the line sensor, where the control means adjusts a light quantity of the line light source by controlling the number of times of lighting signals with a predetermined lighting time width.

### BACKGROUND OF THE INVENTION

1. Technical Field

The present invention relates to an image reading apparatus installed in a copier and facsimile machine to apply light to an original document, receive the reflected light and obtain image data of the document, and more particularly, to light quantity adjustments of a line light source to apply light to the document.

2. Description of the Related Art

As general schemes for reading original document images, there are two schemes. One of the schemes is an image reading scheme provided with an automatic document feeder (ADF) to apply light to an original document, which is read in a fixed position and transported, while transporting the document at a constant velocity to read, and obtain the reflected light, for example, as disclosed in Japanese Laid-Open Patent Publication No. 2004-32570. The other one is an image reading scheme of the carriage traveling type for applying light to an original document mounted on a document mount (platen) made of transparent glass to read the reflected light.

In image reading apparatuses in any of the image reading schemes, image data is acquired by converting an optical image for each predetermined pitch in the sub-scanning direction of an original document into an electric signal by a photoelectric conversion device (referred to as a “line sensor” in the invention) such as a CCD and the like corresponding to the reading resolution.

Conventionally, in order to adjust fluctuations (initial fluctuations and fluctuations due to changes with time) in brightness of the line sensor while reading original document images at a high S/N ratio using the line sensor, and further, to ensure a wide photoelectric conversion range of the line sensor to the extent possible, there have been known inverter lighting control for varying the voltage to apply to the light source, and PWM lighting control for adjusting the voltage application time to the light source (for example, see JP 2007-36770, JP 2003-244395).

Further, as a light source to apply light to the document, cold-cathode tubes have conventionally been used widely. In recent years, since LEDs have been developed which have high emission efficiency and emit in good balance in regions of three primary colors, line light sources with a combination of LEDs have been used. (for example, see JP H06-198958, JP 2008-160582).

Furthermore, since the document moves relatively to the reading means of a carriage or the like, it is known that the reading resolution is improved by shortening the lighting time of the light source in each reading line (for example, see JP H06-198958, JP 2006-201766).

However, in the line light sources of not only the cold-cathode tube but also the LED, as shown in FIG. 12, the hues in turning on (rising A) and turning off (falling C) are different from the hue at the stable lighting time (steady state B). Accordingly, when the line light source for applying light to an original document is subjected to blinking lighting control or PWM lighting control, since the distribution of the wavelength region in the applied light varies with the length of the lighting time, a change occurs in the hue of read data of the document. Particularly, in the case of the blue excitation type of white LED light source where a fluorescent material is irradiated with blue-light, and thereby causes fluorescent emission of red-light and green-light, the intensity of blue color is high at the rising time (A) as compared with the stable lighting time (B), while the intensities of red color and green color are high at the falling time (C), and thus, changes in the hue based on the lighting time are remarkable.

FIG. 13 contains schematic diagrams to explain conventional LED lighting driving, where FIG. 13(a) shows the case that a dark light source is sufficient, and FIG. 13(b) shows the case where a bright light source is required. As can be seen from FIG. 13(b), conventionally, when a bright light source is required, the number of lighting times is the same as that in the dark light source of FIG. 13(a), and a single lighting time of the LED is increased. However, in this case, the ratio of rising/falling (A and B) to the steady state B is different from that in the case of FIG. 13(a), and the above-mentioned change occurs in the hue.

The present invention was made in view of the above-mentioned conventional technical problem, and it is an object of the invention to provide an image reading apparatus capable of reading original document images without causing a change in the hue of read data of the documents, when the image reading apparatus reads the document images while performing control for blinking a line light source in the apparatus.

### BRIEF SUMMARY OF THE INVENTION

To attain the above-mentioned object, the present invention provides an image reading apparatus for applying light to an original document, reading the reflected light, and thereby acquiring image data of the document, where the apparatus has a line light source for applying light to an original document, driving means for moving the document or a carriage installed with the line light source, a line sensor for receiving the reflected light of the document moving in the sub-scanning direction relatively to the carriage to convert into image data, and control means for performing control for blinking the line light source, control for driving the driving means, and control for capturing the image data from the line sensor, and the control means adjusts a light quantity of the line light source by controlling the number of times of lighting signals with a predetermined lighting time width.

Herein, when the image reading apparatus performs image reading in a resolution that is one-Nth a basic resolution, the number of times of lighting signals of the line light source is set at N or more. Further, the number of times of lighting signals in image reading in the basic resolution is set so that the number of times of lighting signals is “2” or more in image reading in the resolution that is one-Nth the basic resolution.

Then, the control means of the image reading apparatus keeps the first lighting timing and last lighting timing of the line light source constant, irrespective of reading resolutions, between line synchronization signals for capturing the image data from the line sensor. By this means, prevented is deterioration of the reading resolution after shipment and due to increases in use time caused by increases in the number of lighting times to compensate for changes with time in the LED light source.

The line light source of the image reading apparatus is formed of one or more LEDs, and the lighting signal of the line light source is output in synchronization with a motor clock signal to a stepping motor constituting the driving means or a signal for defining a storage time of a single line.

### ADVANTAGEOUS EFFECT OF THE INVENTION

According to the image reading apparatus of the invention, when the image reading apparatus reads original document images while performing control for blinking the line light source in the apparatus, it is possible to read the document images without causing a change in the hue of read data of the documents.

### BRIEF DESCRIPTION OF THE SEVERAL VIEWS OF THE DRAWINGS

FIG. 1 is a schematic diagram illustrating principles of lighting control of a line light source in the invention;

FIG. 2 is a schematic diagram to explain control of the number of lighting times of the line light source in the invention;

FIG. 3 is a schematic diagram to explain the number of lighting times of the line light source in the invention;

FIG. 4 is a schematic diagram (case of a bright light source) to explain the relationship between lighting of the line light source and MTF in the invention;

FIG. 5 is another schematic diagram (case of a dark light source) to explain the relationship between lighting of the line light source and MTF in the invention;

FIG. 6 is a schematic diagram (case of a bright light source) to explain the timing of lighting of the line light source in the invention;

FIG. 7 is another schematic diagram (case of a dark light source) to explain the timing of lighting of the line light source in the invention;

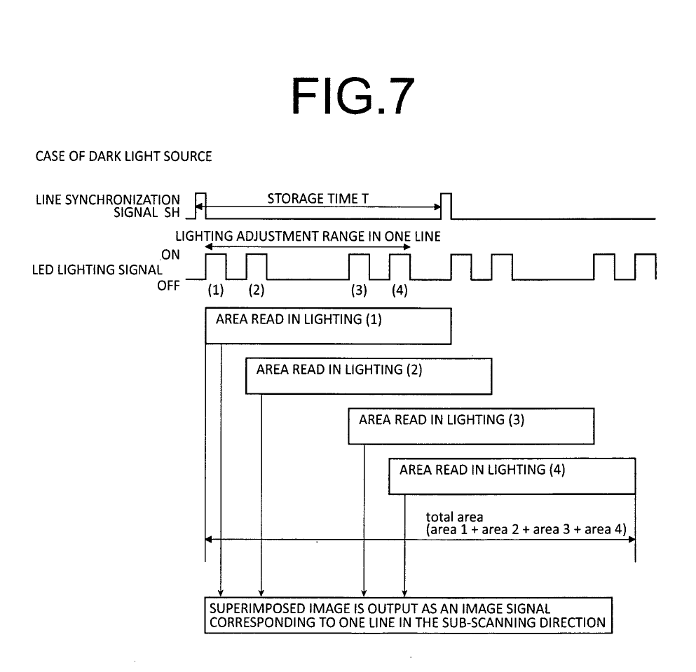

FIG. 8 is a schematic diagram to explain operation of the carriage traveling type image reading apparatus;

FIG. 9 is a schematic diagram (case of the basic resolution) to explain a method of adjusting the number of lighting times of the line light source in the invention;

FIG. 10 is another schematic diagram (case of the basic resolution or less) to explain the method of adjusting the number of lighting times of the line light source in the invention;

FIG. 11 is a block diagram illustrating an electric hardware configuration of the image reading apparatus;

FIG. 12 is a schematic diagram to explain the emission state of LEDs in response to an LED lighting signal; and

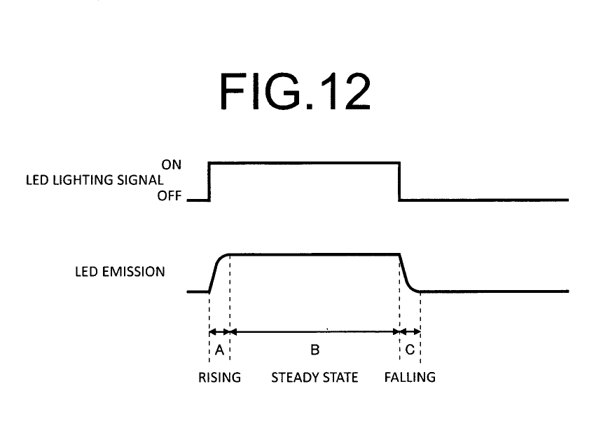

FIG. 13 is a schematic diagram to explain conventional LED lighting driving.

### DETAILED DESCRIPTION OF THE INVENTION

Specific examples of an image reading apparatus according to the invention will be described below based on accompanying drawings.

As described above, as schemes of image reading of original documents, there are the ADF transport reading scheme for reading the image while transporting an original document by ADF, and the carriage traveling reading scheme for reading an original document while moving a carriage with respect to the resting document mounted on a platen. In the following, the invention is described using the carriage traveling reading scheme as an example.

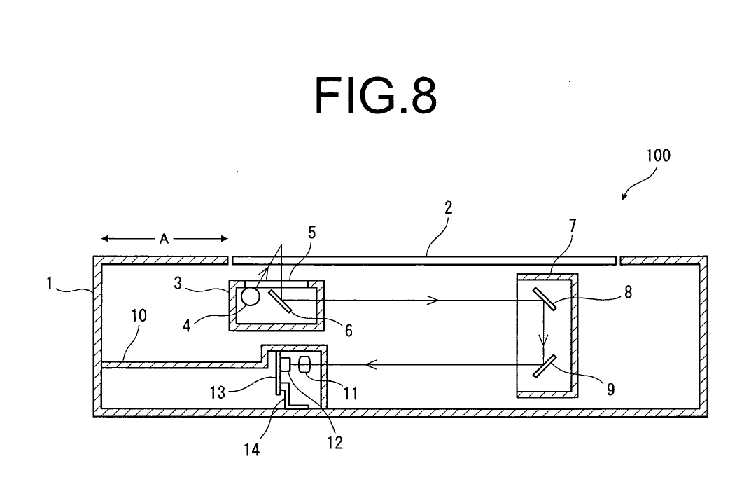

FIG. 8 is a schematic diagram to explain the operation of such a carriage traveling type image reading apparatus 100. As shown in FIG. 8, an original document (not shown) is mounted on a platen 2 attached onto a chassis 1, and a first carriage 3 and second carriage 7 cooperate to project an image on the document to photoelectric conversion elements (line sensor) 12 such as CCDs or the like. The line sensor 12 has a plurality of linearly arranged photoelectric conversion elements, and the direction in which the elements are arranged is referred to as the main scanning direction, while the carriage moving direction (A direction shown by the arrow in FIG. 8) perpendicular to the main scanning direction is referred to as the sub-scanning direction.

The mounted document is irradiated by a light source (for example, an LED line light source formed of one or more LEDs, hereinafter, referred to as “LED”) 4 disposed in the first carriage 3. The diffused light of the applied light is passed through an opening portion 5 of the first carriage 3, and the optical path of the light is changed in the sub-scanning direction by a first mirror 6. The image on the document changed in the optical path is guided downward by a second mirror 8 of the second carriage 7, and next, guided toward a lens 11 by a third mirror 9. Then, the image data condensed by the lens 11 is applied to the line sensor 12 on a CCD board 13 secured to the chassis 1 by an angle 14. In addition, in this embodiment, the LED 4 is formed of a blue LED emission portion, and a coating member containing a yellow fluorescent material covering the blue LED emission portion, where the yellow fluorescent material is excited by light emitted from the blue LED emission portion, the yellow spectrum is superimposed on the spectrum of the blue LED, and the LED chip thus emits white color. Used is a white LED line light source where a plurality of such LED chips is arranged in the main scanning direction.

A driving system is configured so that the first carriage 3 sub-scans (moves in the A direction shown by the arrow in the figure) at a speed twice the speed of the second carriage 7 so as to always keep the constant optical length of from the surface of the document to the lens 11 through a plurality of mirrors 6, 8 and 9.

Further, as well as the two-carriage traveling type image reading apparatus 100 as shown in FIG. 8, one-carriage traveling type image reading apparatuses are applicable where the first carriage 3, second carriage 7 and CCD board 3 are integrally formed.

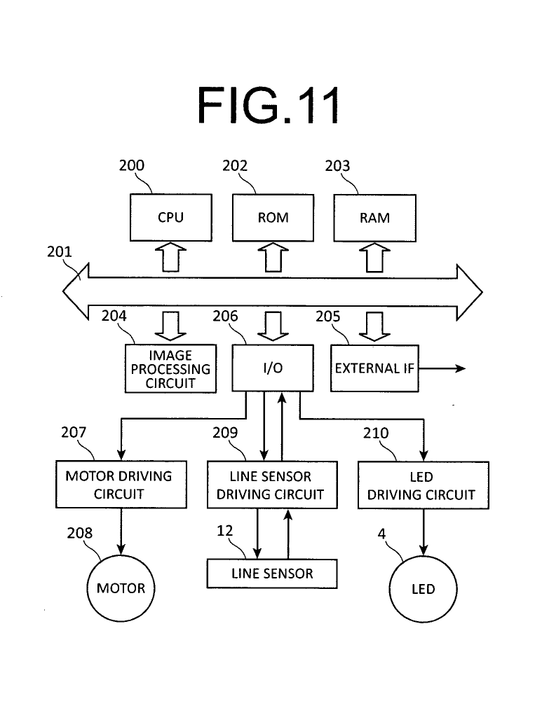

FIG. 11 is a block diagram illustrating an electric hardware configuration of the image reading apparatus 100. A CPU 200 constituting the control means is connected to ROM 202, RAM 203, image processing circuit 204, external interface 205 and I/O port 206 via a system bus 201. Then, via the I/O port 206, the CPU 200 is connected to a motor driving circuit 207 for controlling driving of a motor 208 (formed of a stepping motor) to move the first and second carriages 3 and 7 in the sub-scanning direction, a line sensor driving circuit 209 for controlling reading operation of the line sensor 12, and an LED driving circuit 210 for performing lighting control of the LED 4.

The motor 208 is driven in response to a driving clock CKL with a predetermined period output from the CPU 200, the line sensor 12 performs reading of the document based on a line signal SH for defining the charge transfer timing and storage time of the line sensor 12, and the LED 4 is controlled to light based on ON/OFF of an LED lighting signal output from the LED control circuit 210.

An analog image signal output from the line sensor 12 is converted into a digital signal by an A/D converter inside the line sensor driving circuit 209, input to the image processing circuit 204 via the I/O port 206 and system bus 201, subjected to various kinds of image processing in the circuit 204, and then, transferred to the outside of the apparatus via the external interface IF 205.

In the image reading of the invention, the lighting time of the LED 4 is kept constant so as to prevent changes in the hue caused by short and long lighting times of the LED 4.

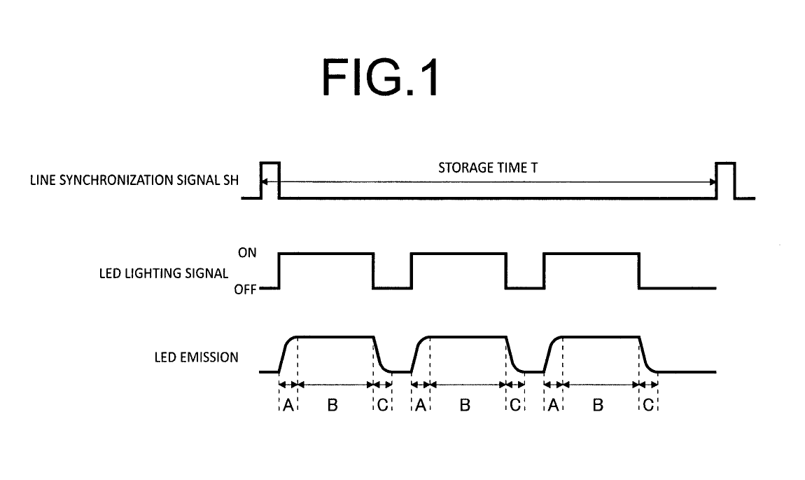

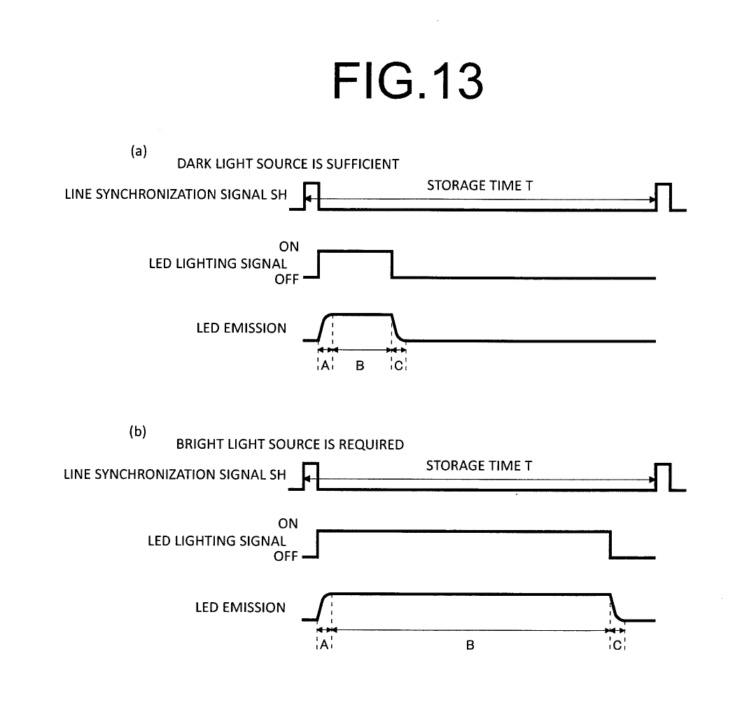

FIG. 1 shows principles of lighting control of the line light source in the invention. As shown in this figure, even when a bright light source is required, the LED is lighted a plurality of times while keeping the steady state B constant (i.e. the output time of ON of the LED lighting signal is always kept constant, while the number of ON times is increased or decreased to control the light), and thereby, the ratio of the rising time and falling time (A, C) of the LED to the steady state B is made constant. By this means, a change in the hue does not occur unlike the light quantity adjustment as shown in FIG. 13(b), and it is possible to obtain images with the same hue as in FIG. 13(a) even by increasing the light quantity.

Thus, in the invention, the lighting time of the LED is made constant, and when an adjustment of the light quantity is required, the number of lighting times is increased or decreased to make the adjustment.

Next, generally, as a means for improving MTF (Modulation Transfer Function) in the sub-scanning direction in the image reading apparatus for blinking the light source during the storage time, there is a technique for decreasing the number of lighting times of the light source during the storage time. However, simply decreasing the number of lighting times develops an area where reading is not performed, and it is necessary to set the appropriate number of lighting times.

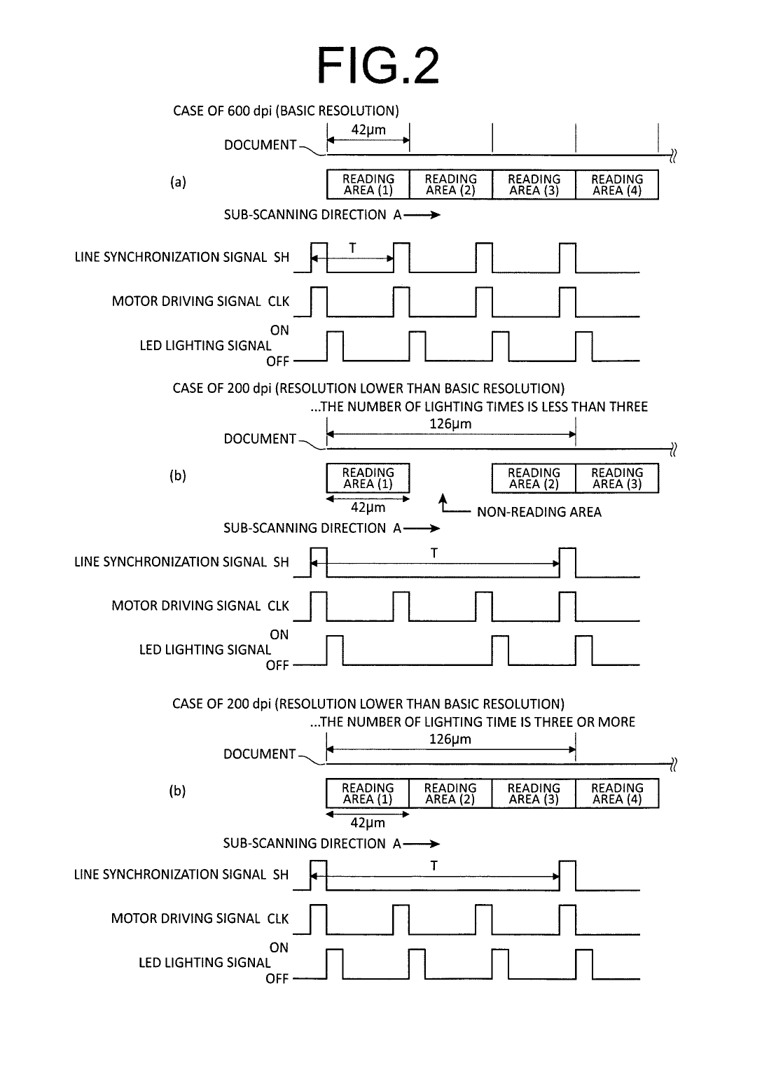

FIG. 2 is a schematic diagram to explain control of the number of lighting times. As an example, described below is the apparatus with a basic resolution of 600 dpi. In addition, the basic resolution is a mechanical resolution of the line sensor, and is determined in combination with the optical system. Herein, since the basic resolution is 600 dpi, a reading area of the line sensor 12 is about 42 μm. Further, the driving system is configured so that the first carriage 3 travels about 42 μm in the sub-scanning direction on the document surface in response to a single motor driving signal CLK. Furthermore, the line sensor 12 performs reading only when the LED is lighted.

As shown in FIG. 2(a), when a reading resolution is the basic resolution of 600 dpi, the LED signal is synchronized to light the LED in synchronization with the mot or driving signal CLK. Further, since the distance (42 μm) that the first carriage 3 travels per motor driving signal CLK is equal to the reading area (42 μm) of the line sensor 12, each reading area [reading area (1) to reading area (4)], where the line sensor 12 performs reading in the sub-scanning direction shown by the arrow A, is adjacent to one another without a gap, and reading is performed normally.

However, as shown in FIG. 2(b), when the basic resolution is 600 dpi and scanning is performed with a 200-dpi reading resolution, the area (126 μm) for the line sensor 12 to read during one storage time T is larger than the reading area (42 μm) of the line sensor 12. Therefore, when the number of LED lighting times is low (i.e. two or less), an area appears where reading cannot be performed. Thus, as shown in FIG. 2(c), lighting is required three or more times at minimum. This number is the number of required lighting times in this resolution. The number of times (the number of required lighting times) the LED is lighted during one storage time T is obtained by dividing the basic resolution by the reading resolution. When there are some reading resolutions, the number of required lighting times is obtained in the lowest resolution, and the number or more is used as the number of lighting times. As an example, described is a case where the basic resolution of the image reading apparatus is 600 dpi, and reading resolutions are 200 dpi, 300 dpi and 600 dpi. In this case, since a value of dividing 600 dpi (basic resolution) by 200 dpi (lowest reading resolution) is “3”, the number of lighting times is set at three or more. Then, the timing of the lighting is determined for each resolution so that each reading area is adjacent to one another without a gap as shown in FIG. 2(c). In addition, the CPU 200 as the control means determines the number of lighting times and lighting timings in each resolution.

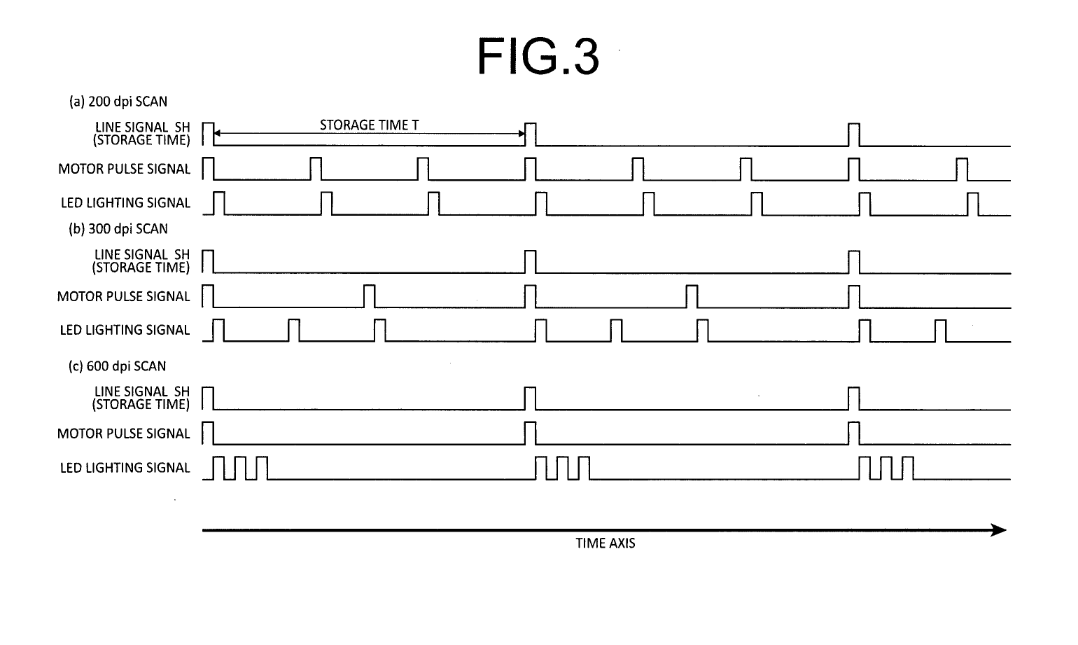

Further, by making the number of lighting times the same irrespective of the resolutions, such a defect does not occur that the lightness varies for each resolution. Then, at this point, the output charge amount of the CCD is determined corresponding to the light quantity of the light source and the sensitivity of the CCD. In general, as shown in FIG. 3, since the storage time of the CCD is the same and the required light quantity of the LED is not changed even when the reading resolution is different, it is necessary to set the same number of lighting times in a line in scanning in each resolution.

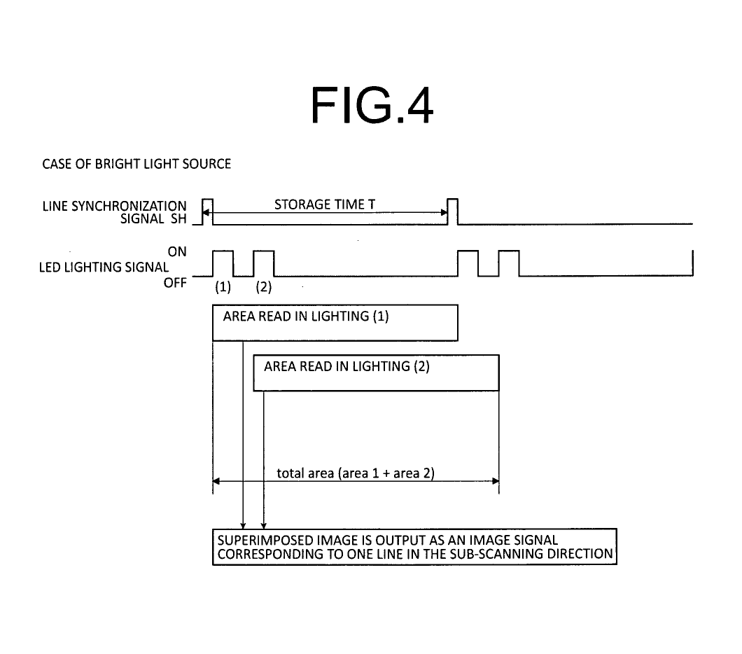

Since the image sensor always moves, as shown in FIG. 4, when the LED is lighted twice during one storage time T, the reading area in the sub-scanning direction read by the line sensor 12 is the total area of combining reading area 1 read at the first lighting time, and reading area 2 read at the second lighting time. Accordingly, as the number of lighting times increases during one storage time, the area read by the image sensor becomes longer, and as a result, the MTF degrades in the sub-scanning direction.

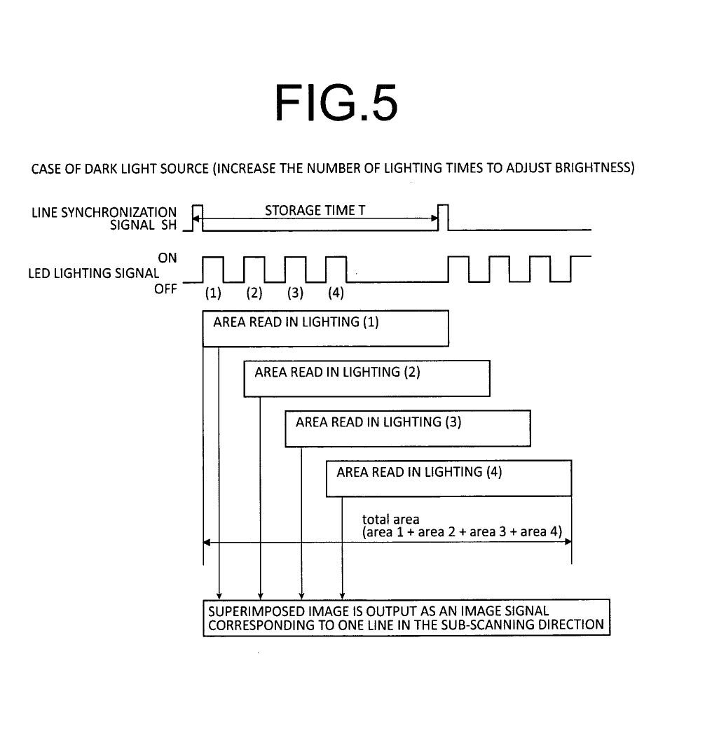

Herein, although the light quantity of the light source decreases according to age and use of the light source, when each pixel of the image sensor always outputs a constant charge irrespective of decreases in the light quantity of the lamp, it is possible to maintain excellent image quality. Accordingly, when the light quantity of the lamp decreases according to age and use of the lamp and the like, it is necessary to increase the number of lighting times during one storage time. However, when the number of lighting times is simply increased, as can be seen from comparison between FIGS. 4 and 5, since the area (total area) becomes wide that is read in a single line (during one storage time), the MTF deteriorates.

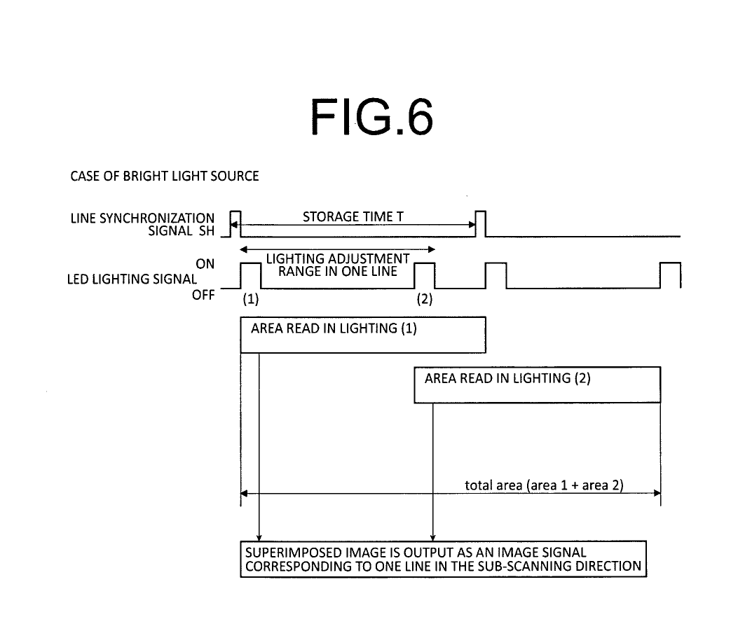

Therefore, in order to prevent the MTF from varying with the number of lighting times as described above, the number of lighting times in a line is made two or more, the LED is certainly lighted at the first and last lighting timings in the lighting adjustment range of the LED, and the number of lighting times is controlled between the first and last timings. In other words, in the case of two-time lighting within one storage time in a bright light source, as shown in FIG. 6, the LED is lighted at the first (1) and last (2) of the lighting adjustment range. Meanwhile, in the case of the need of lighting the LED four times within one storage time in a dark light source, the LED is lighted at the first (1) and last (4) of the lighting adjustment range as in FIG. 6, and further lighted in (2) and (3) between the first and last. By this means, even when the number of lighting times is increased (varied), since the area (total area) read by the line sensor within one storage time is not varied, it is possible to control deterioration of the MTF to be low.

In addition, the above-mentioned lighting signal of the line light source is output in synchronization with a motor clock signal to the stepping motor for driving the carriage or a signal for defining one-line storage time.

As a method of determining the adjustment range of the LED, for example, the following method is considered. Considered first is the case of scanning in the basic resolution or more. For a lighting time t of a single time of the LED, the lighting time t of a single time required for the apparatus is beforehand set corresponding to the storage time, fineness of lighting control and the like. Next, by test or the like, obtained is the number of lighting times (the maximum number of lighting times) in a single line (within one storage time) required to obtain an image sensor output of a certain level necessary for reading in a combination (worst condition) of the time-varied light quantity in the lowest light source (i.e. LED with the lowest light quantity) in the model to use and the line sensor with the lowest sensitivity. In other words, reading of a reference whiteboard is performed under the above-mentioned worst condition, the number of lighting times of the LED is obtained such that the image sensor output in the reading is of a certain target level, and this number of lighting times is set as the maximum number of lighting times.

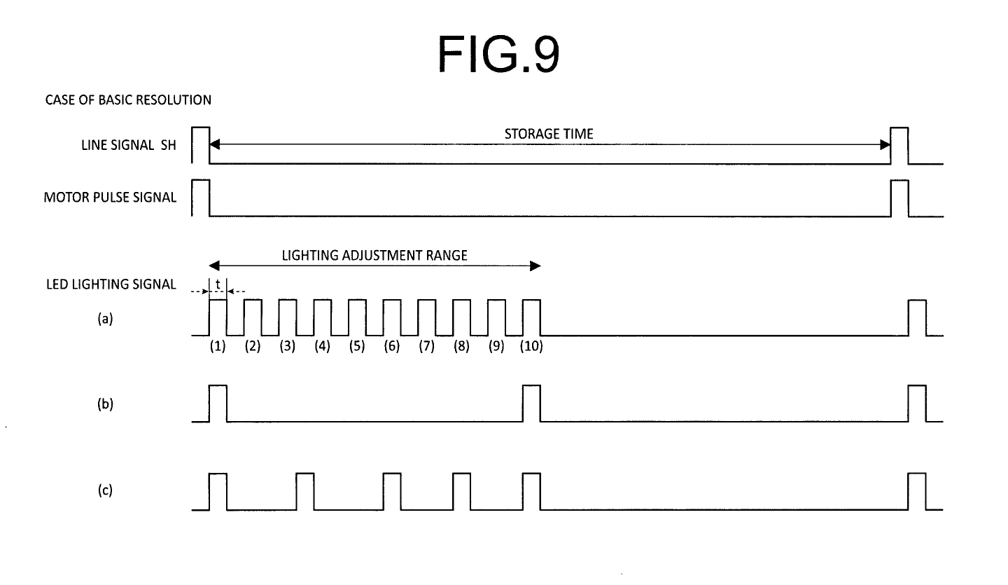

FIG. 9(a) shows the case where the maximum number of lighting times is “10”, and when the lighting time t of a single time and the maximum number of lighting times are determined, the first and last lighting timings (herein, (1) and (10)) of a lighting adjustment range are determined. The above-mentioned description is the method of obtaining the lighting adjustment range that is performed before shipping the products, and the above-mentioned first and last lighting timings are stored in a predetermined area of the ROM 202, etc.

Described next is a specific method of adjusting the number of lighting times.

First, immediately after the user turns the power on in the apparatus, the LED is lighted and reading of the reference whiteboard is performed. The number of lighting times of the LED is obtained such that an image sensor output in the reading is of a certain target level. Then, as shown in FIG. 9(b), when the light quantity of the LED is high and the number of lighting times of the LED is “2” such that an output of the image sensor is of the target level, the CPU 200 lights the LED 4 at two timings of the first (1) and last (10) of the lighting adjustment range. Meanwhile, as shown in FIG. 9(c), when the number of lighting times is two or more (herein, five), the CPU increases or decreases the number of lighting times between the first lighting (1) and last lighting (10) in addition to the first (1) and last (10) lightings, and thereby performs lighting control.

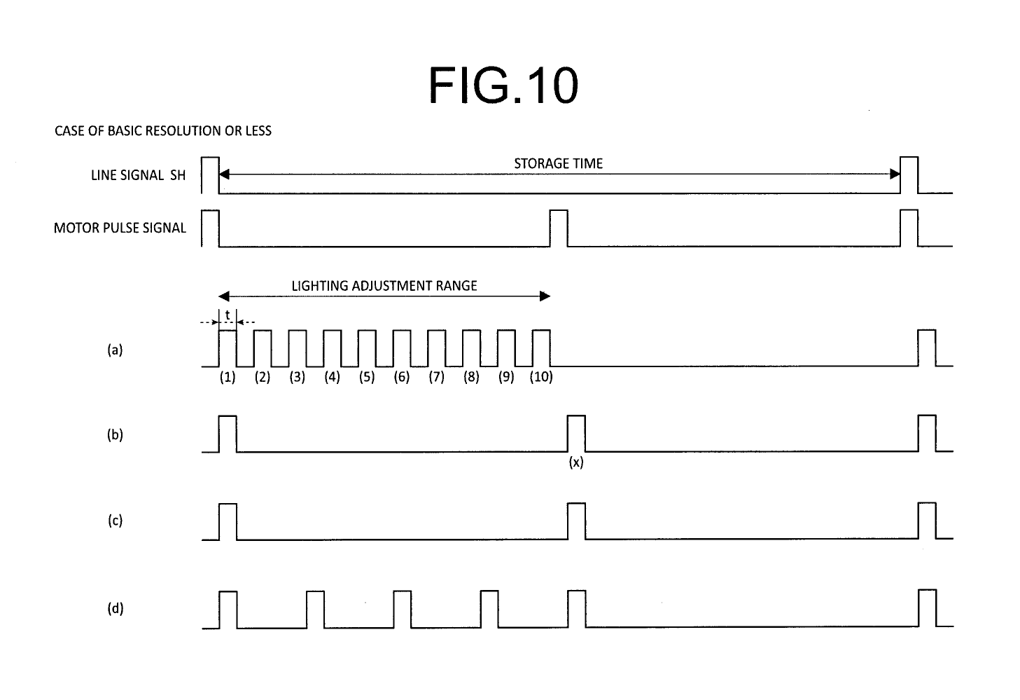

In addition, when scanning is performed in resolutions lower than the basic resolution, the maximum number of lighting times is obtained as described above, and as shown in FIG. 10, the last lighting is of the maximum number of lighting times or a minimum required lighting area without dropout of image reading. For example, as shown in FIGS. 10(a) and 10(b), when the maximum number of lighting times is “10”, the lighting timing x not to cause dropout of reading image is behind the last lighting (10) of the maximum number of lighting times. Therefore, the lighting timing (x) not to cause dropout of reading image is set as the end of the lighting adjustment range. Accordingly, as shown in FIG. 10(c), when the light quantity of the LED is high and the number of lighting times is two such that an output of the image sensor is of the target level, the LED is lighted at two timings i.e. the first (1) and lighting timing (x). Further, as shown in FIG. 9(c), when the number of lighting times is two or more (herein, five), the number of lighting times is increased or decreased between the first (1) and last (X) to perform lighting control.

By configuring as described above, according to the image reading apparatus of the invention, when the image reading apparatus reads original document images while performing control for blinking the line light source in the apparatus, it is possible to read the document images without causing a change in the hue of read data of the documents.

In the foregoing, the embodiment of the present invention is described, but the invention is not limited to the above-mentioned embodiment, and is capable of being modified in various manners based on the subject matter of the invention, and the various modifications are not be excluded from the scope of the invention.

### INDUSTRIAL APPLICABILITY

The present invention relates to the image reading apparatus installed in a copier and facsimile machine to apply light to an original document, receive the reflected light and obtain image data of the document, and more particularly, to light quantity adjustments of the line light source to apply light to the document, and has industrial applicability.

In addition, this application claims priority from Japanese Patent Application No. 2008-288404 incorporated herein by reference.

What is claimed is:

1. An image reading apparatus for applying light to an original document, reading reflected light of the document, and thereby acquiring image data of the document, comprising:
a line light source for applying light to an original document;
driving means for moving the document or a carriage installed with the line light source;
a line sensor for receiving the reflected light of the document moving in a sub-scanning direction relatively to the carriage to convert into image data; and
control means for performing control for blinking the line light source, control for driving the driving means, and control for capturing the image data from the line sensor,
wherein the control means adjusts a light quantity of the line light source by controlling the number of times of lighting signals with a predetermined lighting time width.

2. The image reading apparatus according to claim 1, wherein when the image reading apparatus performs image reading in a resolution that is one-Nth a basic resolution of the apparatus, the number of times of lighting signals of the line light source is set at N or more.

3. The image reading apparatus according to claim 2, wherein the number of times of lighting signals in image reading in the basic resolution is set so that the number of times of lighting signals is “2” or more in image reading in the resolution that is one-Nth the basic resolution.

4. The image reading apparatus according to claim 3, wherein the control means keeps first lighting timing and last lighting timing of the line light source constant, irrespective of reading resolutions, between line synchronization signals for capturing the image data from the line sensor.

5. The image reading apparatus according to claim 1, wherein the line light source is formed of one or more LEDs, and
the lighting signal of the line light source is output in synchronization with a motor clock signal to a stepping motor constituting the driving means or a signal for defining storage time of a single line.
